(19) United States
(12) Patent Application Publication
(10) Pub. No.: US 2006/0151362 A1
(43) Pub. Date: Jul. 13, 2006

(54) Septic Tank Fluid Level Signal

(76) Inventor: James S. Grotenrath, Coopersville, MI (US)

Correspondence Address: MCGARRY BAIR PC, 171 MONROE AVENUE, N.W., SUITE 600, GRAND RAPIDS, MI, 49503, US

(21) Appl. No.: 11/275,500

(22) Filed: Jan. 10, 2006

Related U.S. Application Data
(60) Provisional application No. 60/593,381, filed on Jan. 10, 2005.

(51) Int. Cl. B01D 35/14

(52) U.S. Cl. 210/86; 210/91; 210/121; 210/532.2; 116/200; 73/305

(57) ABSTRACT

A septic tank fluid level signal comprises an indicator movable from a ready position to a deployed position when a fluid level in the septic tank reaches a predetermined fluid level. The septic tank fluid level signal further comprises an actuator responsive to the fluid level and a driver operably coupled with the actuator and the indicator such that the driver instantaneously moves the indicator when the fluid achieves the predetermined fluid level. A housing surrounds at least a portion of the actuator and is permeable to the fluid in the septic tank and impermeable to the scum in the septic tank to protect the actuator from the scum. Further, an adjustable indicator fitting can be mounted to the indicator so that the height of the indicator can be adjusted according to the distance between the septic tank and the top of the ground level.

### CROSS-REFERENCE TO RELATED APPLICATION

This application claims the benefit of U.S. provisional application No. 60/593,381, filed Jan. 10, 2005, which is incorporated herein in its entirety.

### BACKGROUND OF THE INVENTION

1. Field of the Invention

The invention relates to a septic tank signal that communicates a fluid level condition within the septic tank.

2. Description of the Related Art

Homes or other buildings in areas without sewer systems typically have septic systems for the disposal of raw sewage. Septic systems comprise a septic tank and an effluent drain field connected by piping. As shown in FIG. 1, the septic tank 10 is located a short distance beneath ground level 12 and defines a chamber 14 having an inlet 16 from the home into the chamber 14, and an outlet 18 from the chamber 14 to the piping that leads to the effluent drain field. Raw sewage from the home enters the chamber 14 through the inlet 16. The main function of the septic tank 10 is to remove solids from the raw sewage to provide clarified fluid effluent for disposal to the drain field. Within the septic tank 10, the raw sewage is retained in a relatively quiescent body of water long enough to let the solid separate by both settling and flotation. This process results in three products that reside within the chamber: scum 20, sludge 22, and effluent 24. The scum 20 contains substances that are lighter than water and float to the top of the water surface in the chamber 14. The sludge 22, on the other hand, contains sinkable solids that settle to the bottom of the chamber 14. The sludge 22 is denser than water and is fluid, so it forms a flat layer along the tank bottom. While aerobic bacteria digest the floating scum 20, underwater anaerobic bacteria consume organic materials in the sludge 22. During the process, the anaerobic bacteria give off gases and die to become part of the sludge 22. The effluent 24 is the clarified wastewater left over after the scum 20 has floated to the top and the sludge 22 has settled to the bottom. In other words, the effluent 24 is the clarified liquid between the scum 20 and the sludge 22, and it flows through the outlet 18 to leave the septic tank 10 and travel to the effluent drain field.

If clogs develop within the septic system, such as by build-up of sludge near the outlet or backups in the effluent drain field, the septic tank can become full, and, as a result, the raw sewage from the home backs up because it can no longer enter the septic tank. Such situations can lead to extensive damage to the home and require expensive repairs. To avoid these problems, various types of signals ranging from simple mechanical devices to complicated electrical systems have been developed to detect the level of fluid in the septic tank. Some of the mechanical devices comprise a float coupled to an indicator that projects above the ground surface, and the indicator gradually rises with the float as the level of fluid in the septic tank increases. Because the position of the indicator progressively changes, an observer might not be able to readily detect when the level of the fluid in the septic tank achieves a critical level. Examples of electrical signals include lights or audible signals that activate when a switch actuates in response to the level of fluid reaching a critical level. These signals are easy to observe, but they can be expensive to install and maintain. Thus, it is desirable to have a relatively simple and inexpensive septic tank fluid level signal that readily communicates to an observer a critical fluid level condition within the septic tank. Additionally, it is desirable to have such a septic tank fluid level signal that can be easily installed in a variety of septic tanks and can be adjusted according to the depth of the septic tank below the ground surface.

Another problem associated with septic tank fluid level signals is a lack of protection of the signal from the scum layer on top of the fluid effluent. The scum can coat working components of the signal and potentially interfere with the ability of the signal to accurately communicate the level of fluid effluent in the septic tank. Therefore, it is also desirable for a septic tank fluid level signal to be protected from the scum within the septic tank.

### SUMMARY OF THE INVENTION

A septic tank fluid level signal according to the invention comprises an indicator movable from a ready position to a deployed position where the indicator is visually observable; a driver operably connected to the indicator to instantaneously move the indicator from the ready position to the deployed position upon activation of the driver; and an actuator operably coupled to the driver and activating the driver in response to fluid in the septic tank reaching a predetermined fluid level.

The actuator can comprise a lock coupled to the indicator and having a locked condition, wherein the lock secures the indicator in the ready position when the septic tank fluid level is below the predetermined fluid level, and an unlocked condition, wherein the lock releases the indicator when the septic tank fluid achieves the predetermined fluid level to allow movement of the indicator to the deployed position. The actuator can further comprise a float coupled to the lock, and movement of the float in response to an increase in the septic tank fluid level moves the lock from the locked condition to the unlocked condition.

The driver comprises a biasing device to bias the indicator from the ready to the deployed position. The biasing device can be a spring.

The septic tank fluid level signal can further comprise a sleeve that slidably receives the indicator, and the sleeve can be adapted to mount to the septic tank. The indicator can be a rod, and the sleeve can have an open top through which at least a portion of the rod extends when the indicator is in the deployed position. The driver can comprise a biasing device biasing the rod toward the open top of the sleeve. The biasing device can be a coil spring, and movement of the actuator releases the coil spring from a compressed state to an uncompressed state to move the indicator from the ready position to the deployed position. The rod can have an abutment, and the coil spring can abut the abutment at one end thereof to transfer force to the indicator when the coil spring moves from the compressed state to the uncompressed state and thereby effect movement of the indicator from the ready position to the deployed position. The rod can comprise a detent, and a portion of the lock can be received within the detent when the lock is in the locked condition to lock the rod against the force of the biasing device. The lock can be a projection that extends into the detent in the locked condition. The lock can be mounted for pivotal movement between the locked and unlocked conditions. The septic tank fluid level signal can further comprise a float coupled to the projection to pivot the lock from the locked to the unlocked condition in response to the fluid level.

The septic tank fluid level signal can further comprise a housing that encloses the float and is permeable to the fluid in the septic tank and impermeable to scum in the septic tank to protect the float from the scum. The housing can comprise apertures to form the permeability. The housing can comprise a closed top and bottom, and the apertures can be located near the top and the bottom.

The rod can comprise an indicium that is visible when the indicator is deployed. The indicium can comprise a colored portion having first and second colored portions, each having a different color, and the first colored portion is visible when the indicator is in the ready position and the second colored portion is visible when the indicator is in the deployed position.

The indicator can project from the septic tank and above a ground surface when in the deployed position so that the indicator is viewable by an observer.

A septic tank fluid level signal according to the invention comprises an indicator for communicating a level of fluid within a septic tank; an actuator operatively coupled to the indicator and responsive to the level of fluid in the septic tank to activate the indicator; and a housing enclosing at least a portion of the actuator and permeable to the fluid in the septic tank and impermeable to scum in the septic tank to protect the actuator from the scum.

The housing can comprise apertures sized to permit fluid to enter the housing. The housing can comprise a main body with upper and lower ends. The main body can be in the form of a hollow cylinder. The apertures can be formed in the main body and/or in at least one of the upper and lower ends. At least one of the upper and lower ends can be formed by a cap, and the apertures can be formed in the cap.

The septic tank fluid level signal can further comprise a driver operably connected to the actuator and the indicator to instantaneously move the indicator from a ready position to a deployed position, where the indicator is visually observable, upon activation of the driver by the actuator when the fluid in the septic tank reaches a predetermined level. The actuator can comprise a float mounted within the housing and responsive to the level of fluid in the housing to activate the driver. The indicator can be slidably mounted to the housing such that movement of the float in response to the fluid in the housing reaching the predetermined level releases the driver to move the indicator relative to the housing to visually communicate the level of fluid in the septic tank.

A signal according to the invention for communicating a level of fluid in a septic tank located a distance beneath a ground level comprises an indicator movable relative to the ground level for communicating above the ground level the level of fluid within the septic tank, the indicator being adjustable to accommodate for the distance between the septic tank and the ground level; and an actuator operatively coupled to the indicator and responsive to the level of fluid in the septic tank to displace the indicator vertically relative to the ground level to communicate the level of fluid within the septic tank.

The indicator can be adjustable in height to accommodate for the distance between the septic tank and ground level. The indicator can comprise an adjustable indicator fitting that is adjustable in height to accommodate for the distance between the septic tank and the ground level. The fitting can be severable to effect the adjustable height. The indicator can comprise an upper end that extends from the septic tank, and the adjustable indicator fitting is mounted on the upper end of the indicator. The adjustable indicator fitting can be removably mounted to the upper end of the indicator. The adjustable indicator fitting can comprise an elongated indicator portion and a mount portion wherein the mount portion receives the upper end of the indicator to mount the adjustable indicator fitting to the indicator. The adjustable indicator fitting can be made from fiberglass.

### BRIEF DESCRIPTION OF THE DRAWINGS

In the drawings:

FIG. 1 is a sectional view of an exemplary septic tank.

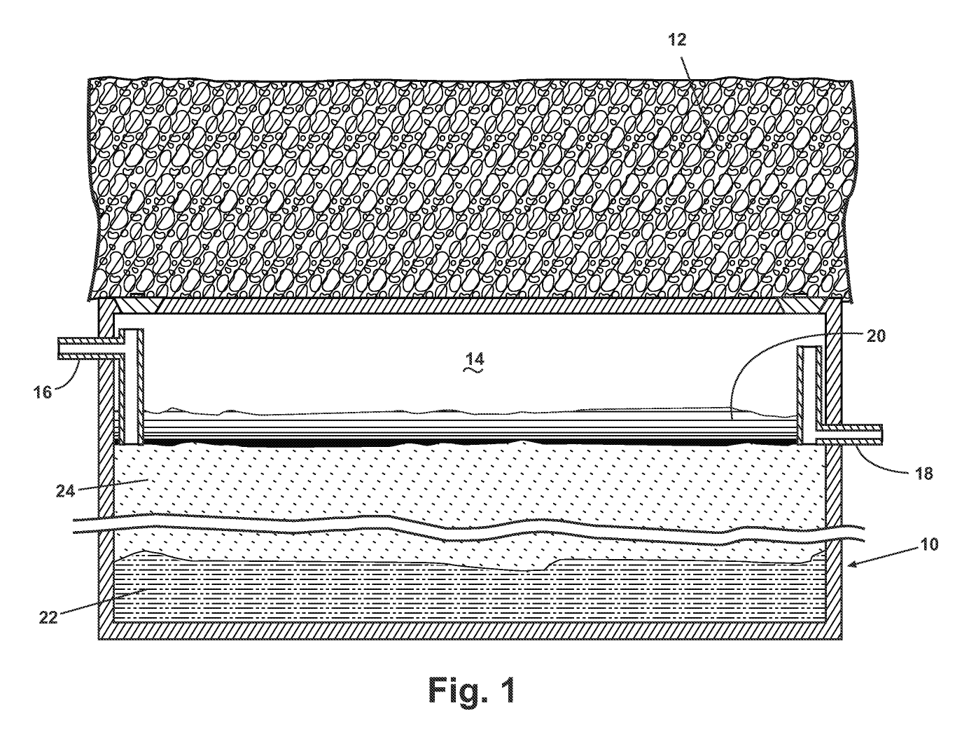

FIG. 2 is a sectional view of a septic tank with a septic tank fluid level signal according to the invention.

FIG. 3 is a perspective view of the septic tank fluid level signal of FIG. 2.

FIG. 4 is an exploded view of the septic tank fluid level signal of FIG. 2.

FIG. 5 is a sectional view of the septic tank fluid level signal of FIG. 2 with an actuator assembly in a charged condition and an indicator in a ready position.

FIG. 6 is an enlarged view of the region marked VI in FIG. 5.

FIG. 7 is a sectional view of the septic tank fluid level signal of FIG. 2 with the actuator assembly in a discharged condition and the indicator in a deployed position.

FIG. 8 is a sectional view of the septic tank and the septic tank fluid level from FIG. 2, wherein the actuator assembly is in the discharged condition and the indicator is in the deployed position shown in FIG. 7.

FIG. 9 is a perspective view of an alternative embodiment of a septic tank fluid level signal according to the invention.

FIG. 10 is a sectional view of the region marked X in FIG. 9.

FIG. 11 is a sectional view of a septic tank with the septic tank fluid level signal of FIG. 9.

### DESCRIPTION OF THE PREFERRED EMBODIMENT

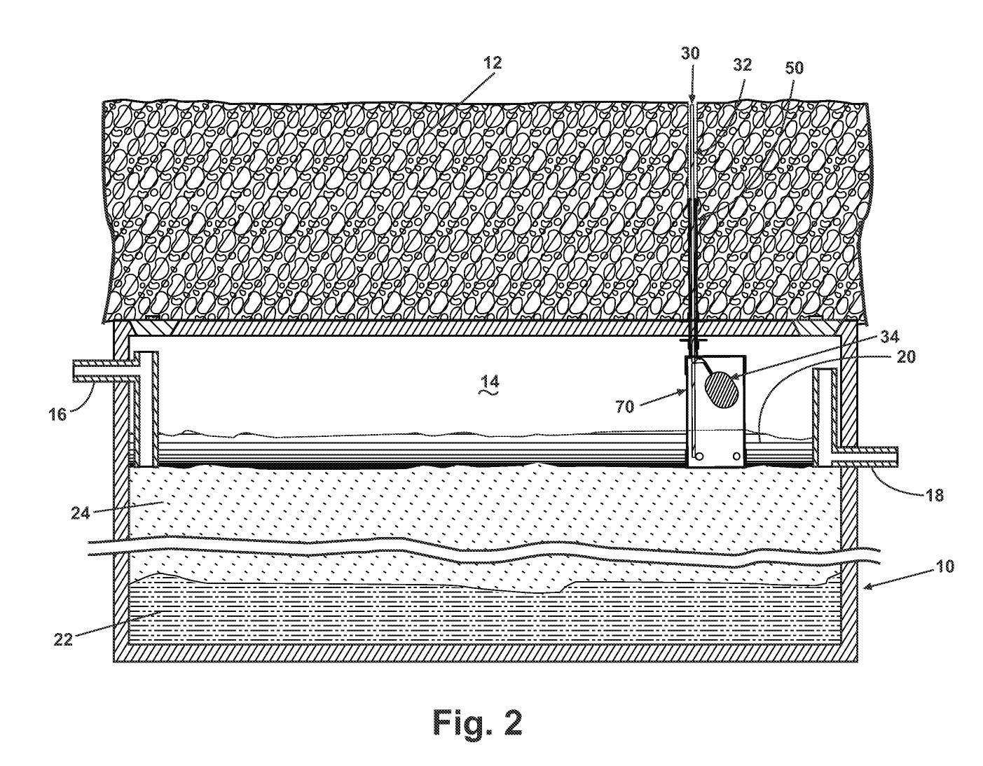

Referring now to the figures, FIG. 2 illustrates a septic tank 10 equipped with a septic tank fluid level signal 30 according to the invention. The septic tank 10 shown in the figures is for illustrative purposes, and the fluid level signal 30 can be used with any suitable septic tank 10. As described in the background of the invention, the septic tank 10 is located a short distance beneath ground level 12 and defines a chamber 14 having an inlet 16 that brings raw sewage from the home into the chamber 14, and an outlet 18 through which fluid effluent travels to leave the chamber 14 and flow to the drain field. The fluid level signal 30 is mounted within the chamber 14 and extends though the septic tank 10 and the ground level 12 to communicate to an observer when a level of fluid effluent within the chamber 14 has achieved a predetermined fluid level.

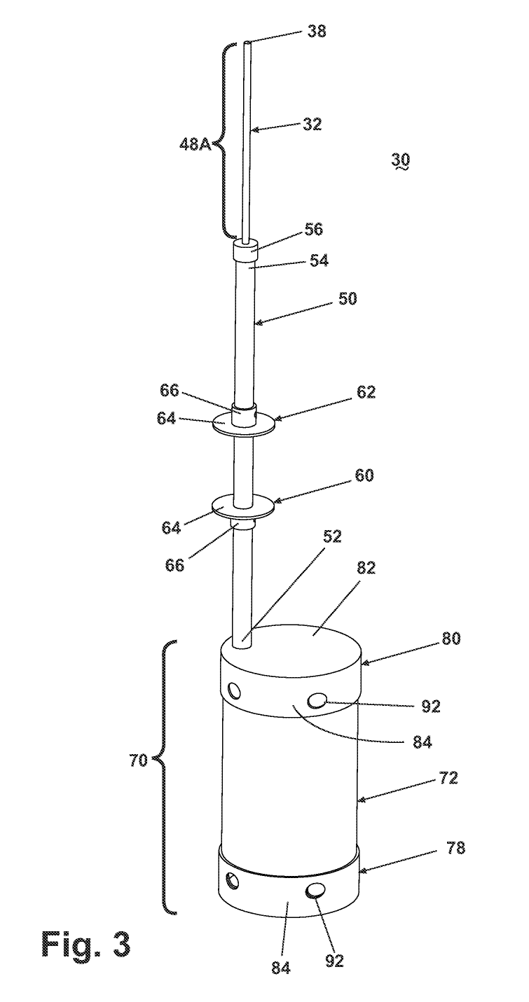

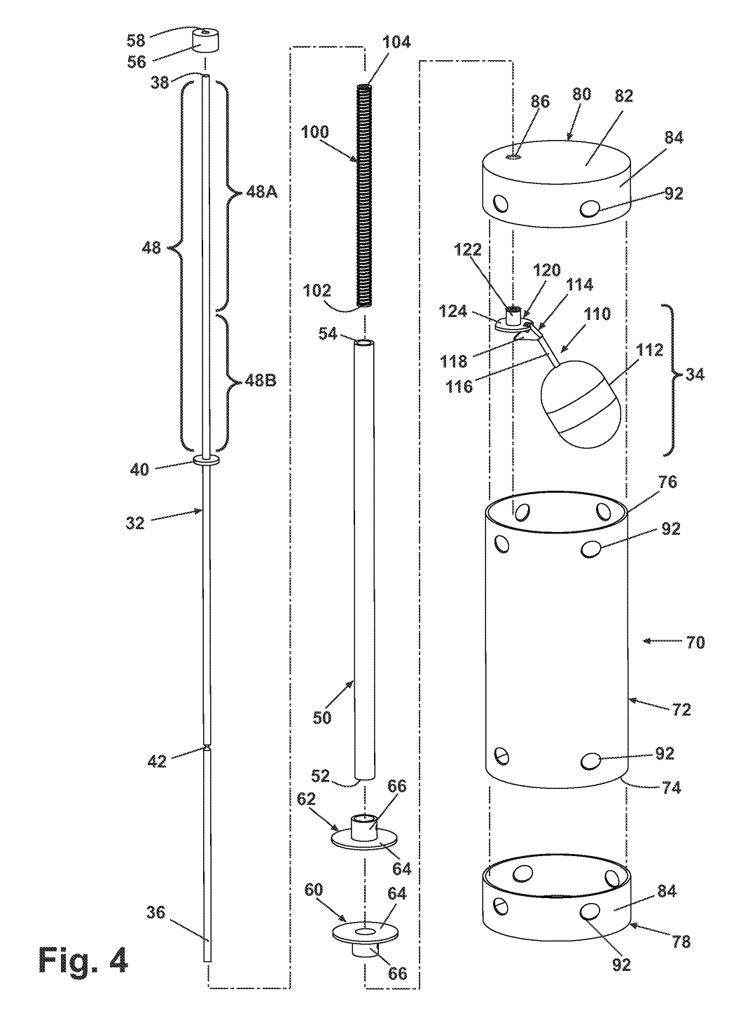

Referring now to FIGS. 3-5, the fluid level signal 30 comprises an indicator 32 coupled to an actuator assembly 34 that deploys the indicator 32 when the fluid level in the septic tank reaches the predetermined fluid level. The indicator 32 is an elongated rod with a lower end 36, an upper end 38, and an abutment 40 between the lower and upper ends 36, 38. The abutment 40 is shown as generally circular flange extending radially outward from the indicator 32 but can be of any suitable shape or size. The indicator 32 also includes a detent 42 in the form of a V-shaped notch located between the lower end 36 and the abutment 40. The detent 42 has an inclined lower release surface 44 and an inclined upper stop surface 46 that join to form the “V” shape. The indicator 32 is slidingly mounted within a protecting sleeve 50 having a lower end 52 and an upper end 54 and a length shorter than that of the indicator 32. The sleeve 50 is covered by a cap 56 at the upper end 54, and the cap forms an aperture 58 sized to slidingly receive the indicator 32. Further, a pair of spaced mounting flanges, a lower mounting flange 60 and an upper mounting flange 62, surround the sleeve 50 to facilitate mounting the fluid level signal 30 to the septic tank 10, as will be described hereinafter. Each of the mounting flanges 60, 62 comprises an annular disc 64 and an integral, hollow cylindrical boss 66 sized to snugly fit around the sleeve 50.

The lower end 36 of the indicator 32 is disposed within a housing 70 formed by a cylindrical main body 72 with open lower and upper ends 74, 76 closed by lower and upper end caps 78, 80, respectively. Each of the upper and lower end caps 78, 80 comprises a planar wall 82 and a peripheral wall 84 oriented generally orthogonal to the planar wall 82. Additionally, the upper end cap 80 includes an opening 86 formed in the planar wall 82 and sized to slidingly receive the indicator 32. The main body 72 and the end caps 78, 80 define a chamber 90 that fluidly communicates with the chamber 14 of the septic tank 10 through a plurality of apertures 92 formed in the housing 70. Preferably, the apertures 92 are located near the lower and upper ends 74, 76 of the main body 72 and in the peripheral walls 84 of the end caps 78, 80 and are spaced so that the apertures 92 in the peripheral walls 84 of the end caps 78, 80 align with the apertures 92 in the main body 72. The apertures 92 are sized so that the housing 70 is permeable to the fluid effluent in the septic tank 10 but substantially impermeable to the scum and other substances floating on or in the fluid effluent.

The actuator assembly 34 for deploying the indicator 32 is operatively coupled to a driver preferably in the form of a biasing device 100. The biasing device 100 can be any suitable element that applies a biasing force to the indicator 32 and is preferably a coil spring with a lower end 102 and an upper end 104. The biasing device 100 surrounds the indicator 32 beneath the abutment 40, as will be described in more detail hereinafter.

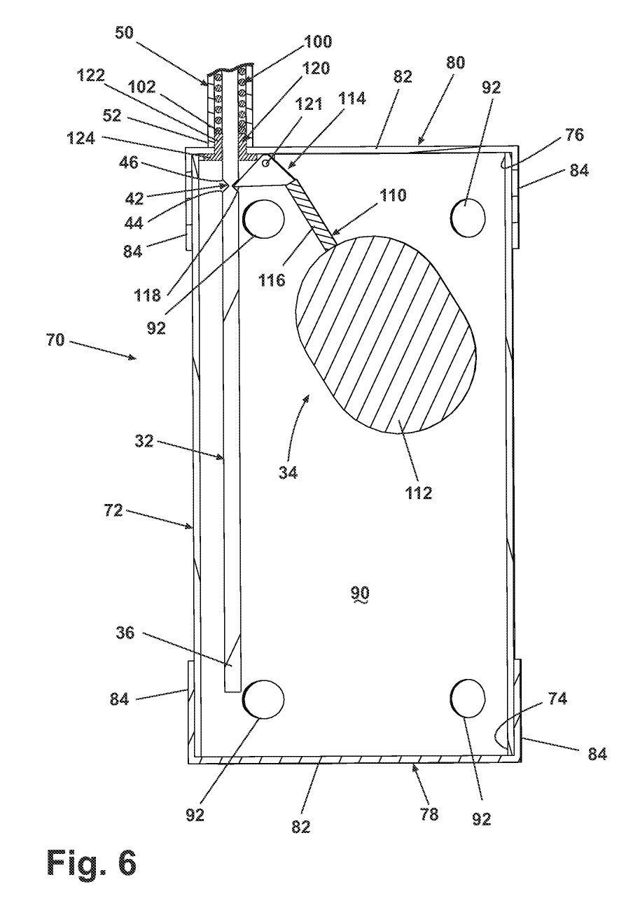

Referring additionally to FIG. 6, the actuator assembly 34 comprises a float assembly 110 that resides within the chamber 90 of the housing 70 and includes a float 112 connected to a lock 114 by a shaft 116. The lock 114 is generally triangular and is joined to the shaft 116 at a first corner, has a projection 118 sized to be received by the detent 42 in the indicator 32 at a second corner, and is pivotally mounted to a bracket 120 at a third corner by a pin 121. The bracket 120 comprises a hollow, cylindrical bearing 122 and an annular flange 124 that extends outward from a lower end of the bearing 122. The lock 114 is pivotally mounted to the annular flange 124, and the bearing 122 is sized to slidingly receive the indicator 32 and to be received by the opening 86 of the upper end cap 80 and the sleeve 50. The float 112 is designed to be sufficiently heavy to cause the lock 114 to pivot in the direction of the projection 118 yet float on the surface of the fluid effluent in the septic tank 10 when the level of the fluid effluent reaches the float 112.

An exemplary description of the assembly of the fluid level signal 30 follows. It will be apparent to one of ordinary skill that the assembly procedure can proceed in any logical order and is not limited to the sequence presented below. The following description is for illustrative purposes only and is not intended to limit the invention in any manner.

To assemble the fluid level signal 30, the bearing 122 on the bracket 120 of the float assembly 110 is inserted into the opening 86 of the upper end cap 80 such that the weight of the float 112 forces the float 112 to pivot about the pin 121 in a generally downward direction away from the upper end cap 80. Next, the sleeve 50 is attached to the upper end cap 80 of the housing 70 above the opening 86 and with lower end 52 of the sleeve 50 surrounding the bearing 122 that projects through the opening 86 to form a seal therebetween. The main body 72 is then mounted to the upper end cap 80 with the respective apertures 92 aligned, and the lower end cap 78 is mounted to the main body 72 with the respective apertures 92 also aligned.

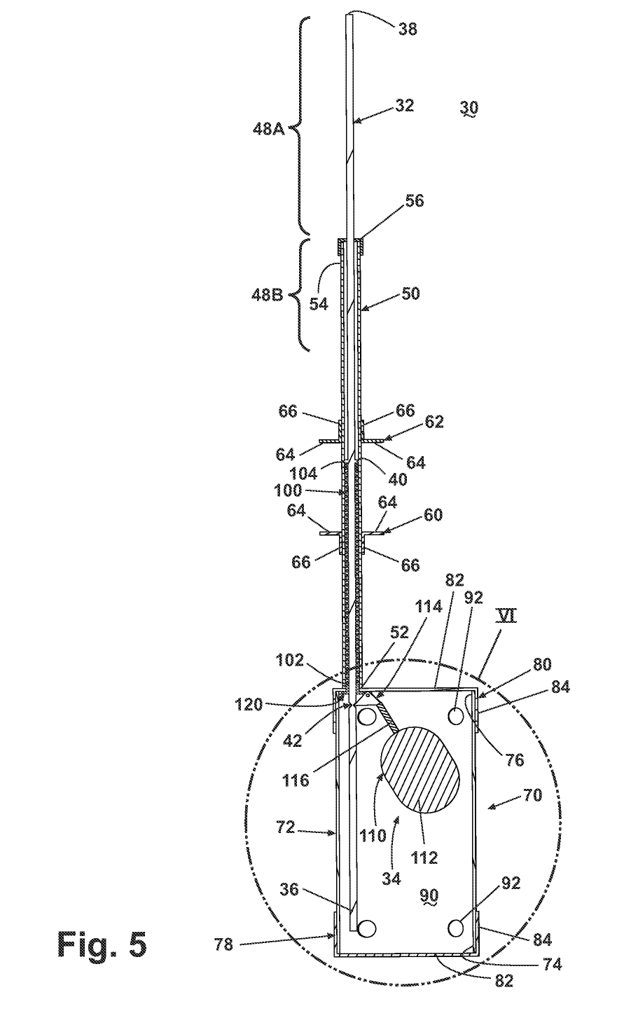

Once the housing 70 is assembled with the float assembly 110 therein, the lower end 36 of the indicator 32 is inserted into the upper end 104 of the biasing device 100 until the upper end 104 of the biasing device 100 abuts the abutment 40, and the indicator 32 and the biasing device 100 are inserted into upper end 54 of the sleeve 50. During the insertion of the indicator 32 and the biasing device 100 into the sleeve 50, the biasing device 100 achieves a position where the upper end 104 is against the abutment 40 and the lower end 102 abuts the bearing member 122. Insertion of the indicator 32 continues whereby the abutment 40 moves closer to the housing 70, the lower end 36 of the indicator 32 enters the chamber 90, and the biasing device 100 compresses. As the indicator 32 moves downward within the chamber 90, the projection 118 on the lock 114 of the float assembly 110 rides along the indicator 32. The insertion terminates when the projection 118 rides along the lower release surface 44 of the detent 42 and abuts the upper stop surface 46 to come to rest in the detent 42. As shown in FIGS. 5 and 6, the lock 114 assumes a locked condition and remains in the locked condition due to the weight of the float 112 and the interaction of the lock 114 with the upper stop surface 46. Additionally, the biasing device 100 is compressed between the bearing 122 and the abutment 40 and, therefore, exerts an upward, biasing force on the indicator 32. However, because the lock 114 is the locked condition with the projection 118 in the detent 42, the biasing device 100 is not free to force the indicator 32, which is in a ready position, upward within the sleeve 50. With the lock 114 in the locked condition and the biasing device 100 in the compressed state, the actuator assembly 34 is said to be in a charged condition.

With the actuator assembly 34 charged and the indicator 32 in the ready position, the lower mounting flange 60 is positioned on the sleeve 50 with the disc 64 facing upward. Next, the fluid level signal 30 is positioned in the septic tank 10 with the sleeve 50 extending through the septic tank 10 and the disc 64 of the lower mounting flange 60 abutting the inside surface of the septic tank 10. The position of the lower mounting flange 60 can be adjusted so that the position of the float 112 in the septic tank 10 corresponds to a predetermined fluid level corresponding to a critical fluid level indicative of a full or near-full septic tank 10. The upper mounting flange 62, with the disc 64 facing downward, is then slid onto the upper end 54 of the sleeve 50 until the disc 64 abuts the outside surface of the septic tank 10. As a result, the lower and upper mounting flanges 60, 62 sandwich the septic tank 10 to mount the fluid level signal 30 thereto. The lower and upper mounting flanges 60, 62 can be secured to the septic tank 10 with fasteners, adhesive, or by other suitable joining methods. Finally, the cap 56 is slid over the upper end 38 of the indicator 32 and mounted to the upper end 54 of the sleeve 50. When the septic tank 10 is buried beneath the ground level 12, the cap 56 of the sleeve 50 is preferably about 10 inches below the top of the ground level 12, and the indicator 32 is preferably flush with or just below the top of the ground level 12, as shown in FIG. 2.

An exemplary description of the operation of the fluid level signal 30 follows. It will be apparent to one of ordinary skill that the operation procedure can proceed in any logical order and is not limited to the sequence presented below. The following description is for illustrative purposes only and is not intended to limit the invention in any manner.

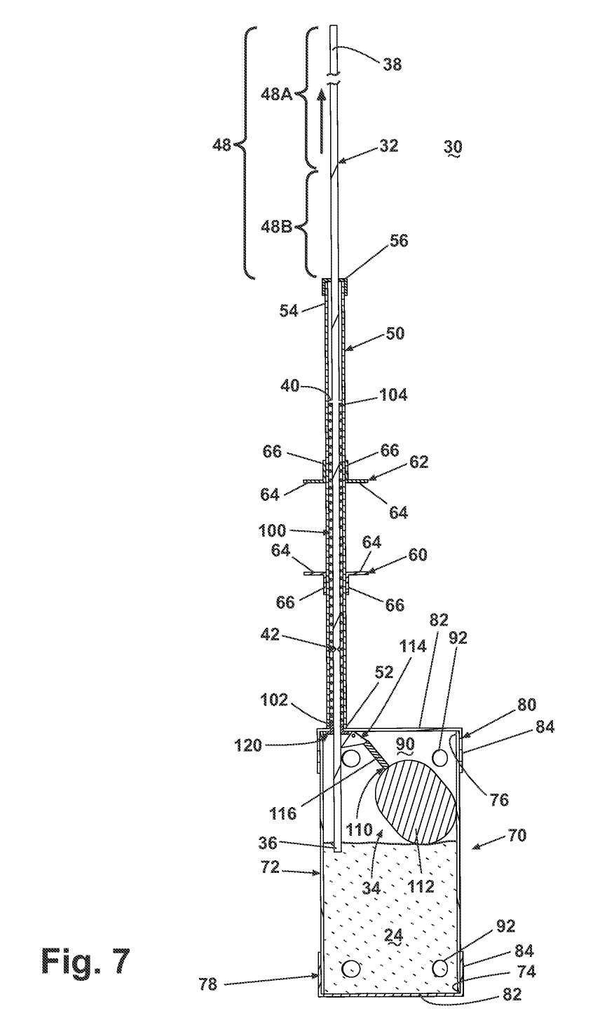

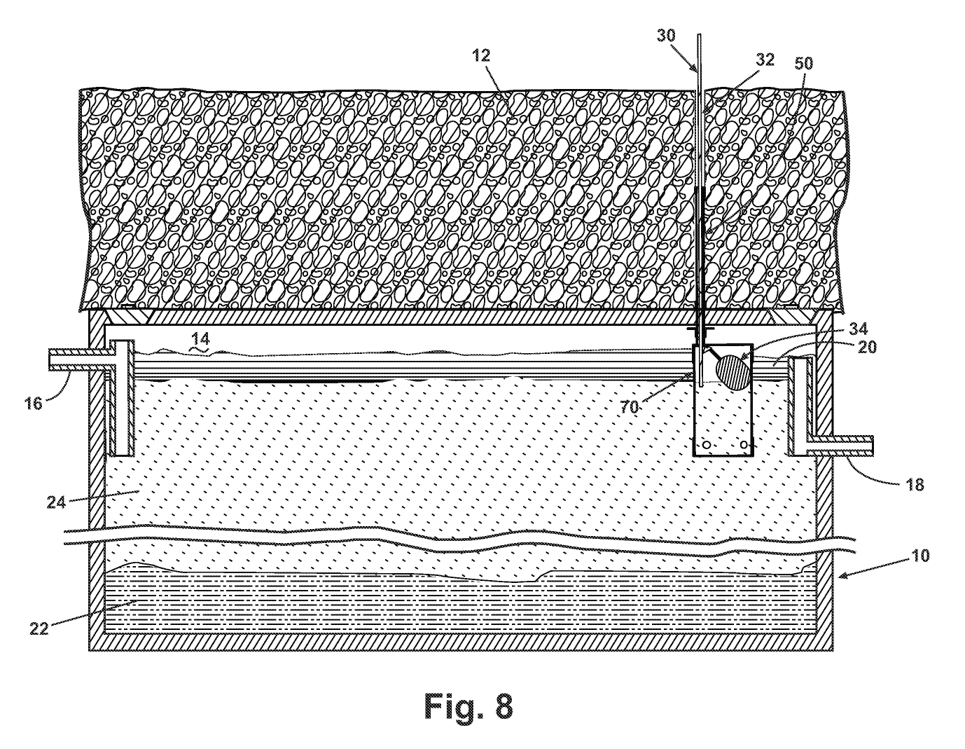

Under normal operating conditions, the level of the fluid effluent in the septic tank 10 is below the predetermined fluid level and, therefore, below the float 112 in the housing 70 of the fluid level indicator 30. Consequently, the weight of the float 112 maintains the lock 114 in the locked condition with the projection 118 in the detent 42, and, correspondingly, the biasing device 100 is held in the compressed state and the indicator 32 is in the ready position, as shown in FIGS. 5 and 6. When a clog develops in the septic system and the level of the fluid effluent in the septic tank 10 rises, the fluid effluent enters the chamber 90 through the apertures 92 in the lower end cap 78 and the lower end 74 of the main body 72. When the level of the fluid effluent 24 reaches the float 112, the float 112 rises with the fluid effluent 24. When the fluid effluent 24 achieves the predetermined fluid level, as illustrated in FIGS. 7 and 8, the float 112 causes the lock 114 to pivot about the pin 121 whereby the projection 118 rides along the lower stop surface 46. When the projection 118 pivots out of the detent 42, the lock 114 assumes an unlocked condition, and the actuator assembly 34 is said to be in a discharged condition. The biasing device 100, which is no longer restrained by the lock 114, moves from the compressed state to an uncompressed state. Because the upper end 104 of the biasing device 100 abuts the abutment 40, the biasing device 100 pushes the indicator 32 upward, and the indicator 32 rapidly slides within the sleeve 50 to a deployed position, wherein the upper end 38 of the indicator 32 is noticeably displaced upward relative to the top of the ground level 12 and is visually observable.

Upon noticing the deployed indicator 32, an observer can readily recognize that the level of the fluid effluent in the septic tank 10 is at or above the predetermined fluid level and can take the necessary steps to diagnose and fix the problem before detrimental damage occurs to home and/or septic system. After the fluid level signal 30 has been deployed, the fluid level signal 30 can easily be reset by manually pushing the indicator 32 downward in the sleeve 50 until the projection 118 engages the detent 42 and thereby locks the lock 114, placing the biasing device 100 in the compressed state, and sets the indicator 32 in the ready position.

During the use of the fluid level signal 30, the float assembly 110 and the lower end 36 of the indicator 32 are protected by the housing 70. The housing 70 is preferably made of a material that is impervious to the fluid effluent and scum, and the apertures 92 are advantageously sized so that the housing 70 is be permeable to the fluid effluent but impermeable to the scum and other items floating in or on the fluid effluent. Consequently, the scum and any other items floating in or on the fluid effluent cannot enter the housing 70 to interfere with the operation of the fluid level signal 30. The apertures 92 can have any suitable shape or size to deter the entry of scum and other items into the chamber 90. For example, the apertures 92 can be elongated slits, rectangular, oval, or irregularly shaped. The apertures 92 can be located anywhere in the housing 70, such as in the planar wall 82 of the end caps 78, 80, anywhere in the main body 72, or only at one end of the housing 70. Alternatively, the housing 70 can be made of a material that is permeable to the fluid effluent but impermeable to the scum in lieu of or in addition to comprising the apertures 92.

By changing various aspects of the float assembly 110, the distance over which the float 112 must rise to unlock the lock 114 can be adjusted according to a user's preferences. For example, the float assembly 110 can be configured so that only a small movement or, conversely, a relatively large movement, of the float 112 is required to pivot the lock 114 and thereby unlock the lock 114. Examples of features of the float assembly 110 that can be adjusted include, but are not limited to, the angle between the shaft 116 and the projection 118, the length of the shaft 116, and the shape of the float 112.

The predetermined fluid level as utilized in the description above corresponds to a condition where the fluid effluent in the septic tank reaches a critical level or is indicative of a clog or other problem associated with the septic system. The predetermined fluid level depends on the type of septic tank and can be adjusted depending on the degree of caution desired by the observer of the fluid level signal 30. For example, if the observer desires a high level of caution, the fluid level signal 30 can be positioned lower in the septic tank 10 so that the float 112 rises when the level of the fluid effluent is relatively low.

Optionally, the indicator 32 can comprise indicia 48, as shown in the figures, to facilitate communication of the level of the fluid effluent to an observer. For example, when the fluid level signal 30 is installed such that in the ready position the upper end 38 of the indicator 32 is flush with or below the top of the ground level 12, the indicia 48 can be a single color that becomes visible when the indicator 32 is in the deployed position. Alternatively, when the fluid level signal 30 is installed such that in the ready position a portion of the upper end 38 extends above the ground level 12, the upper end 38 of the indicator 32 can be color coded such that a first portion 48A of the indicator 32 that projects beyond the sleeve 50 and above the ground level 12 is a first color, such as green, and a second portion 48B, located below the first portion, that becomes visible when the indicator 32 is in the deployed position is a second color, such as red. Another exemplary indicium is an indicator flag that becomes visible when the indicator 32 is deployed.

Advantageously, the fluid level signal 30 can be adjusted according to the distance between the ground level 12 and the septic tank 10 and to accommodate various types of septic tanks. For example, the fluid level signal 30 can be provided with a relatively tall shaft 50 and a relatively tall indicator 32 that can be shortened to a desired height that is suitable for the distance between the ground level 12 and the septic tank 10. Alternatively, the fluid level signal 30 can be provided with shafts 50 and indicators 32 of varying heights, and the shafts 50 and the indicators 32 can be removably mounted to the housing 70 so that the fluid level signal 30 can be optimized for varying septic tank environments.

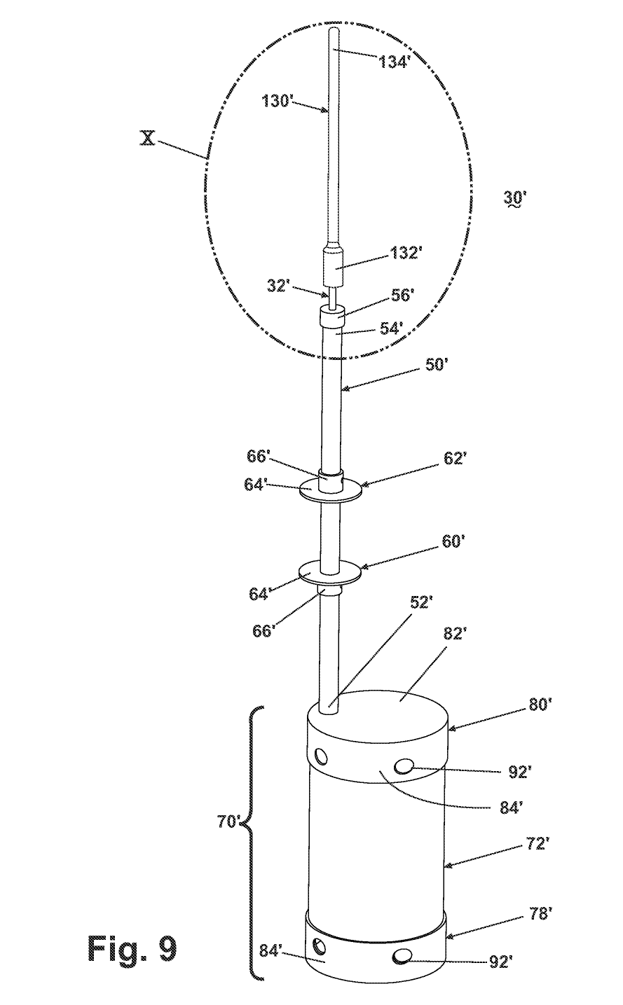

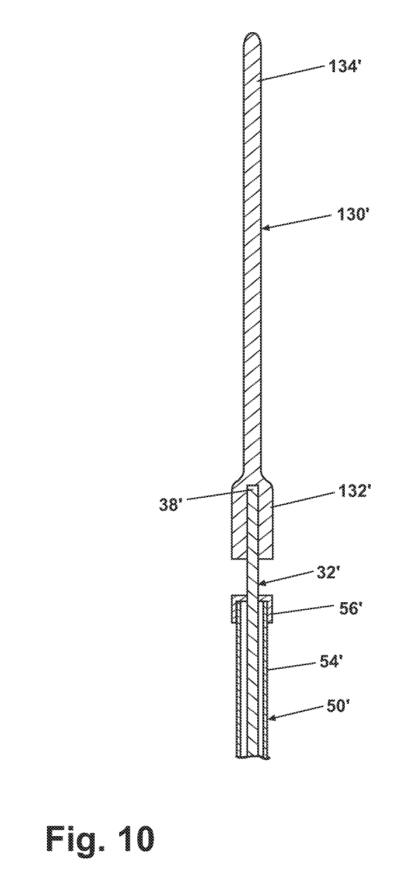

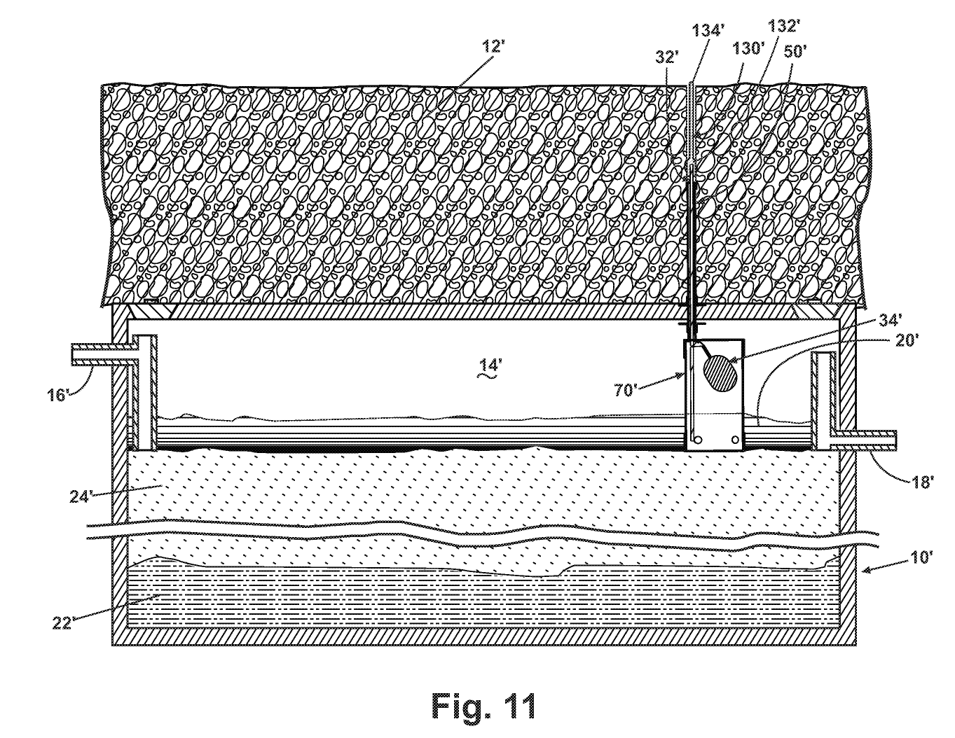

An alternative embodiment of a fluid level signal 30′ according to the invention is illustrated in FIGS. 9-11, where components similar with the first embodiment fluid level signal 30 are identified with the same reference numeral bearing a prime symbol (′). The fluid level signal 30′ is substantially identical to the fluid level signal 30 of the first embodiment, except that the indicator 32′ is shorter than the indicator 32 to accommodate an indicator fitting 130′ mounted to the upper end 38′ of the indicator 32′. The indicator fitting 130′ comprises a solid elongated indicator portion 134′ integral with a hollow lower mount 132′ sized to receive the upper end 38′ of the indicator 32′ for removably mounting the indicator fitting 130′ to the indicator 32′. The indicator fitting 130′ and the indicator 32′ together function in the same manner as the indicator 32 of the first embodiment fluid level signal 30.

When mounted to the indicator 32′, the indicator fitting 130′ is essentially an extension of the indicator 32′ and renders the height of the indicator 32′ adjustable. The indicator fitting 130′ defines an indicator height, which is the combined height of the indicator 32′ and the indicator fitting 130′ when the indicator fitting 130′ is mounted to the indicator 32′. The indicator portion 134′ of the indicator fitting 130′ is preferably supplied in a relatively long height and can be cut or otherwise manually severed to adjust the indicator height for accommodating a particular septic tank 10′ and the distance between the septic tank 10′ and the top of the ground level 12′. Consequently, the indicator 32′ can be made of a material, such as a material that is resistant to manual severing, different from the material of the indicator fitting 130′ while maintaining adjustability of the fluid level signal 30′. The indicator fitting 130′ can be made of any suitable material that can be easily severed and is preferably made from fiberglass.

Assembly of the fluid level signal 30′ is substantially the same as the assembly of the first embodiment fluid level signal 30. The primary difference between the assembly procedures relates to mounting the indicator fitting 130′ to the indicator 32′. The indicator fitting 130′ is preferably mounted to the indicator 32′ after the septic tank 10′ is buried beneath the ground level 12′. After the septic tank 10′ is buried, the indicator fitting 130′ is inserted through the ground level 12′ and mounted to the upper end 38′ of the indicator 32′. Thereafter, the indicator portion 134′ is severed to a desired height so that the indicator portion 134′ is at a desirable height relative to the top of the ground level 12′. Consequently, the fluid level signal 30′ can be mounted within a variety of septic tanks 10′ prior to installation under the ground level 12′ and modified after the septic tank 10′ is buried under the ground level 12′ for the particular type of septic tank 10′ and the location of the septic tank 10′ beneath the ground level 12′ by adjusting the height of the indicator fitting 130′.

The fluid level signal 30 according to the invention is a relatively inexpensive yet reliable, adjustable, and readily observable device that effectively communicates to an observer when the level of the fluid effluent in the septic tank 10 reaches a predetermined level. Because the biasing device 100 rapidly moves the indicator 32 from the ready position to the deployed position, and the appearance of the indicator 32 in the deployed position is easily discernable from the appearance of the indicator 32 in the ready position, the observer can immediately determine whether the septic system requires immediate maintenance to avoid damage to the home and/or the septic system. Further, the housing 70 protects the actuator assembly 34 from the scum and other substances floating in and/or on the fluid effluent and thereby ensures that the scum and other substances do not affect the performance of the fluid level signal 30. While the fluid level signal 30 has been described as comprising the housing 70, it is within the scope of the invention for the fluid level signal 30 to be used without the housing 70, and the housing 70 can be used with other types of fluid level signals. Furthermore, the indicator cap 132′ can be utilized with other types of fluid level signals in addition to the fluid level signal 30′ disclosed herein.

While the invention has been specifically described in connection with certain specific embodiments thereof, it is to be understood that this is by way of illustration and not of limitation, and the scope of the appended claims should be construed as broadly as the prior art will permit.

What is claimed is:

1. A septic tank fluid level signal comprising:
an indicator movable from a ready position to a deployed position where the indicator is visually observable;
a driver operably connected to the indicator to instantaneously move the indicator from the ready position to the deployed position upon activation of the driver; and
an actuator operably coupled to the driver and activating the driver in response to fluid in the septic tank reaching a predetermined fluid level.

2. The septic tank fluid level signal according to claim 1, wherein the actuator comprises a lock coupled to the indicator and having a locked condition, wherein the lock secures the indicator in the ready position when the septic tank fluid level is below the predetermined fluid level, and an unlocked condition, wherein the lock releases the indicator when the septic tank fluid achieves the predetermined fluid level to allow movement of the indicator to the deployed position.

3. The septic tank fluid level signal according to claim 2, wherein the actuator further comprises a float coupled to the lock and movement of the float in response to an increase in the septic tank fluid level moves the lock from the locked condition to the unlocked condition.

4. The septic tank fluid level signal according to claim 1, wherein the driver comprises a biasing device to bias the indicator from the ready to the deployed position.

5. The septic tank fluid level signal according to claim 4, wherein the biasing device is a spring.

6. The septic tank fluid level signal according to claim 2 and further comprising a sleeve that slidably receives the indicator, and the sleeve is adapted to mount to the septic tank.

7. The septic tank fluid level signal according to claim 6, wherein the indicator is a rod and the sleeve has an open top through which at least a portion of the rod extends when the indicator is in the deployed position.

8. The septic tank fluid level signal according to claim 7, wherein the driver comprises a biasing device biasing the rod toward the open top of the sleeve.

9. The septic tank fluid level signal according to claim 8, wherein the biasing device is a coil spring and movement of the actuator releases the coil spring from a compressed state to an uncompressed state to move the indicator from the ready position to the deployed position.

10. The septic tank fluid level signal according to claim 9, wherein the rod has an abutment, and the coil spring abuts the abutment at one end thereof to transfer force to the indicator when the coil spring moves from the compressed state to the uncompressed state and thereby effect movement of the indicator from the ready position to the deployed position.

11. The septic tank fluid level signal according to claim 8, wherein the rod comprises a detent and a portion of the lock is received within the detent when the lock is in the locked condition to lock the rod against the force of the biasing device.

12. The septic tank fluid level signal according to claim 11, wherein the lock is a projection that extends into the detent in the locked condition.

13. The septic tank fluid level signal according to claim 12, wherein the lock is mounted for pivotal movement between the locked and unlocked conditions.

14. The septic tank fluid level signal according to claim 13, and further comprising a float coupled to the projection to pivot the lock from the locked to the unlocked condition in response to the fluid level.

15. The septic tank fluid level signal according to claim 14, and further comprising a housing that encloses the float and is permeable to the fluid in the septic tank and impermeable to scum in the septic tank to protect the float from the scum.

16. The septic tank fluid level signal according to claim 15, wherein the housing comprises apertures to form the permeability.

17. The septic tank fluid level signal according to claim 16, wherein the housing comprises a closed top and bottom and the apertures are located near the top and the bottom.

18. The septic tank fluid level signal according to claim 7, wherein the rod comprises an indicia that is visible when the indicator is deployed.

19. The septic tank fluid level signal according to claim 18, wherein the indicia comprises a colored portion having first and second colored portions, each having a different color, and the first colored portion is visible when the indicator is in the ready position and the second colored portion is visible when the indicator is in the deployed position.

20. The septic tank fluid level signal according to claim 1, wherein the indicator projects from the septic tank and above a ground surface when in the deployed position so that the indicator is viewable by an observer.

21. The septic tank fluid level signal according to claim 1 and further comprising a housing that encloses at least a portion of the actuator and is permeable to the fluid in the septic tank and impermeable to scum in the septic tank to protect the at least a portion of the actuator from the scum.

22. The septic tank fluid level signal according to claim 21, wherein the housing comprises apertures sized to permit fluid to enter the housing.

23. The septic tank fluid level signal according to claim 22, wherein the housing comprises a closed top and bottom and the apertures are located near the top and the bottom.

24. A septic tank fluid level signal comprising:
an indicator for communicating a level of fluid within a septic tank;
an actuator operatively coupled to the indicator and responsive to the level of fluid in the septic tank to activate the indicator; and
a housing enclosing at least a portion of the actuator and permeable to the fluid in the septic tank and impermeable to scum in the septic tank to protect the actuator from the scum.

25. The septic tank fluid level signal according to claim 24, wherein the housing comprises apertures sized to permit fluid to enter the housing.

26. The septic tank fluid level signal according to claim 25, wherein the housing comprises a main body with upper and lower ends.

27. The septic tank fluid level signal according to claim 26, wherein the main body is in the form of a hollow cylinder.

28. The septic tank fluid level signal according to claim 26, wherein the apertures are formed in the main body.

29. The septic tank fluid level signal according to claim 26, wherein the apertures are formed in at least one of the upper and lower ends.

30. The septic tank fluid level signal according to claim 26, wherein at least one of the upper and lower ends is formed by a cap.

31. The septic tank fluid level signal according to claim 30, wherein the apertures are formed in the cap.

32. The septic tank fluid level signal according to claim 24 and further comprising a driver operably connected to the actuator and the indicator to instantaneously move the indicator from a ready position to a deployed position, where the indicator is visually observable, upon activation of the driver by the actuator when the fluid in the septic tank reaches a predetermined level.

33. The septic tank fluid level signal according to claim 32, wherein the actuator comprises a float mounted within the housing and responsive to the level of fluid in the housing to activate the driver.

34. The septic tank fluid level signal according to claim 33, wherein the indicator is slidably mounted to the housing such that movement of the float in response to the fluid in the housing reaching the predetermined level releases the driver to move the indicator relative to the housing to visually communicate the level of fluid in the septic tank.

35. A signal for communicating a level of fluid in a septic tank located a distance beneath a ground level, the signal comprising:
an indicator movable relative to the ground level for communicating above the ground level the level of fluid within the septic tank, the indicator being adjustable to accommodate for the distance between the septic tank and the ground level; and
an actuator operatively coupled to the indicator and responsive to the level of fluid in the septic tank to displace the indicator vertically relative to the ground level to communicate the level of fluid within the septic tank.

36. The signal according to claim 35, wherein the indicator is adjustable in height to accommodate for the distance between the septic tank and ground level.

37. The signal according to claim 36, wherein the indicator comprises an adjustable indicator fitting that is adjustable in height to accommodate for the distance between the septic tank and the ground level.

38. The signal according to claim 37, wherein the fitting is severable to effect the adjustable height.

39. The signal according to claim 38, wherein the indicator comprises an upper end that extends from the septic tank, and the adjustable indicator fitting is mounted on the upper end of the indicator.

40. The signal according to claim 39, wherein the adjustable indicator fitting is removably mounted to the upper end of the indicator.

41. The signal according to claim 40, wherein the adjustable indicator fitting comprises an elongated indicator portion and a mount portion wherein the mount portion receives the upper end of the indicator to mount the adjustable indicator fitting to the indicator.

42. The signal according to claim 41, wherein the adjustable indicator fitting is made from fiberglass.
